(19) United States
(12) Patent Application Publication
(10) Pub. No.: US 2016/0369635 A1
(43) Pub. Date: Dec. 22, 2016

(54) PLATING A COMPOSITE TO ENHANCE BONDING OF METALLIC COMPONENTS

(71) Applicant: UNITED TECHNOLOGIES CORPORATION, Hartford, CT (US)

(72) Inventors: JinQuan XU, East Greenwich, RI (US); Grant O. COOK, III, Spring, TX (US)

(21) Appl. No.: 14/903,872

(22) PCT Filed: Jul. 9, 2014
(86) PCT No.: PCT/US2014/046013

§ 371 Date: Jan. 8, 2016

Related U.S. Application Data
(60) Provisional application No. 61/844,108, filed on Jul. 9, 2013.

(51) Int. Cl. F01D 5/28; B32B 7/12; B32B 37/12; C23C 18/16; C23C 18/22; C23C 18/20; C23C 28/02; C25D 3/38; C25D 3/46; C25D 3/02; C25D 5/48; F01D 9/02; F04D 29/32; F04D 29/54; B32B 15/08

(52) U.S. Cl. CPC F01D 5/288; B32B 15/08; B32B 7/12; B32B 37/1284; C23C 18/1633; C23C 18/22; C23C 18/2013; C23C 28/02; C25D 3/38; C25D 3/46; C25D 3/02; C25D 5/48; F01D 9/02; F04D 29/324; F04D 29/542; B33Y 10/00

(57) ABSTRACT

A composite component is disclosed. The composite component may comprise a metal plating deposited on a surface of the composite component, and a metallic feature adhesively bonded to the metal plating. The composite component may further comprise an adhesive layer between the metal plating and the metallic feature. The metal plating may provide a metal-to-metal interface between the surface of the composite component and the metallic feature.

### CROSS-REFERENCE TO RELATED APPLICATIONS

This application claims priority under 35 U.S.C. §119(e) to U.S. Provisional Patent Application Ser. No. 61/844,108 filed on Jul. 9, 2013.

### FIELD OF THE DISCLOSURE

The present disclosure generally relates to composite components. More specifically, this disclosure relates to adhesive bonding arrangements between composite components and metallic components.

### BACKGROUND

Composite materials may consist of a polymeric matrix reinforced with metals and/or reinforcing fibers such as glass fibers or carbon fibers. Components formed from composite materials may be adhesively bonded on one or more of their surfaces to metallic components for various reasons, such as to protect the composite material from erosion or to structurally reinforce the underlying region of the composite material. As one example, metallic sheaths may be bonded to composite airfoils of gas turbine engine fans along their leading edges to structurally reinforce the leading edge and protect it from impact with foreign objects. However, the selection and optimization of suitable adhesives which are capable of establishing good interfacial shear strength between both the metallic feature and the adhesive as well as the composite material and the adhesive can prove to be a significant challenge. In particular, it is difficult to select or develop an adhesive which bonds well with both metallic materials and with composite materials. For example, when selecting an appropriate adhesive for a metal, properties which are favorable for bonding to polymeric materials may be compromised.

Clearly, there is a need for systems designed to improve adhesive bonding arrangements between composite materials and metallic materials.

### SUMMARY OF THE DISCLOSURE

In accordance with one aspect of the present disclosure, a composite component is disclosed. The composite component may comprise a metal plating on a surface of the composite component, and a metallic feature adhesively bonded to the metal plating. The composite component may further comprise an adhesive layer between the metal plating and the metallic feature.

In another refinement, the metal plating may provide a metal-to-metal interface between the surface of the composite component and the metallic feature.

In another refinement, the composite component may be formed from a polymeric matrix.

In another refinement, the polymeric matrix may be reinforced with fibers selected from the group consisting of metal fibers, carbon fibers, and glass fibers.

In another refinement, the polymeric matrix may be a thermoplastic material or a thermoset material.

In another refinement, the metallic feature may be formed from a metal or a metal alloy selected from the group consisting of titanium, nickel, and a nickel-cobalt alloy.

In another refinement, the composite component may be an airfoil of a gas turbine engine.

In another refinement, the surface of the composite component may be a leading edge of the airfoil, and the metallic feature may be a sheath configured to protect the leading edge.

In accordance with another aspect of the present disclosure, a method for fabricating a composite component adhesively bonded to a metallic feature is disclosed. The method may comprise forming the composite component in a desired shape, and depositing a metal plating on a surface of the composite component. The method may further comprise selecting an adhesive for bonding the metallic feature to the metal plating of the composite component, and adhesively bonding the metallic feature to the metal plating using the selected adhesive.

In another refinement, selecting the adhesive for bonding the metallic feature to the metal plating may comprise selecting an adhesive capable of providing a bond at a metal-to-metal interface.

In another refinement, forming the composite component in a desired shape may comprise forming the composite component from a thermoplastic material or a thermoset material.

In another refinement, forming the composite component in a desired shape may comprise forming the composite component from a thermoplastic material or a thermoset material, and the thermoplastic material or the thermoset material may have fibers embedded therein.

In another refinement, forming the composite component in a desired shape may comprise forming the composite component by a method selected from the group consisting of injection molding, compression molding, blow molding, additive manufacturing, and composite layup.

In another refinement, depositing the metal plating on the surface of the component may comprise: 1) preparing the surface of the composite component to receive a catalyst by etching, abrasion, or reactive-ion etching, 2) depositing a catalyst layer on the surface of the composite component, 3) depositing a first layer on the catalyst layer by electroless deposition, 4) depositing a second layer on the first layer by electrolytic deposition, wherein the second layer is conductive, and 5) depositing the metal plating on the second layer.

In another refinement, depositing the metal plating on the second layer is performed by a method selected from the group consisting of electroplating, electroless plating, and electroforming.

In accordance with another aspect of the present disclosure, a composite component adhesively bonded to a metallic feature is disclosed. The composite component may be fabricated by a method comprising: 1) forming the composite component in a desired shape, 2) depositing a metal plating on a surface of the composite component, 3) selecting an adhesive for bonding the metallic feature to the metal plating of the composite component, and 4) adhesively bonding the metallic feature to the metal plating using the selected adhesive.

In another refinement, selecting the adhesive for bonding the metallic feature to the metal plating may comprise selecting an adhesive capable of providing a bond at a metal-to-metal interface.

In another refinement, forming the composite component in a desired shape may comprise forming the composite component from a thermoplastic material or a thermoset material.

In another refinement, depositing the metal plating on the surface of the component may comprise: 1) preparing the surface of the composite component to receive a catalyst by etching, abrasion, or reactive-ion etching, 2) depositing a catalyst layer on the surface of the composite component, 3) depositing a first layer on the catalyst layer by electroless deposition, 4) depositing a second layer on the first layer by electrolytic deposition, wherein the second layer is conductive, and 5) depositing the metal plating on the second layer.

In another refinement, the composite component may be an airfoil of a gas turbine engine, and the metallic feature may be a sheath configured to protect a leading edge of the airfoil.

These and other aspects and features of the present disclosure will be more readily understood when read in conjunction with the accompanying drawings.

### BRIEF DESCRIPTION OF THE DRAWINGS

FIG. 1 is a cross-sectional view of a composite component adhesively bonded to a metallic feature constructed in accordance with the present disclosure.

FIG. 2 is an exploded view of detail 2 of FIG. 1, illustrating a metal plating and an adhesive layer between the composite component and the metallic feature.

FIG. 3 is a flow chart illustrating steps involved in forming the composite component adhesively bonded to the metallic feature, in accordance with a method of the present disclosure.

It should be understood that the drawings are not necessarily drawn to scale and that the disclosed embodiments are sometimes illustrated schematically and in partial views. It is to be further appreciated that the following detailed description is merely exemplary in nature and is not intended to limit the invention or the application and uses thereof. In this regard, it is to be additionally appreciated that the described embodiment is not limited to use for certain applications. Hence, although the present disclosure is, for convenience of explanation, depicted and described as certain illustrative embodiments, it will be appreciated that it can be implemented in various other types of embodiments and in various other systems and environments.

### DETAILED DESCRIPTION

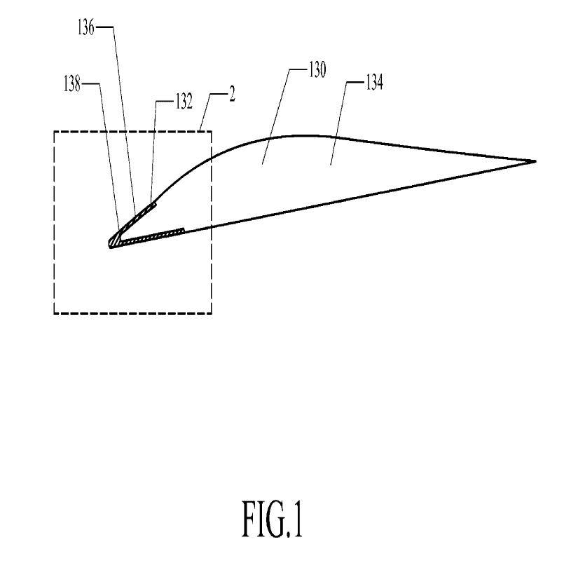

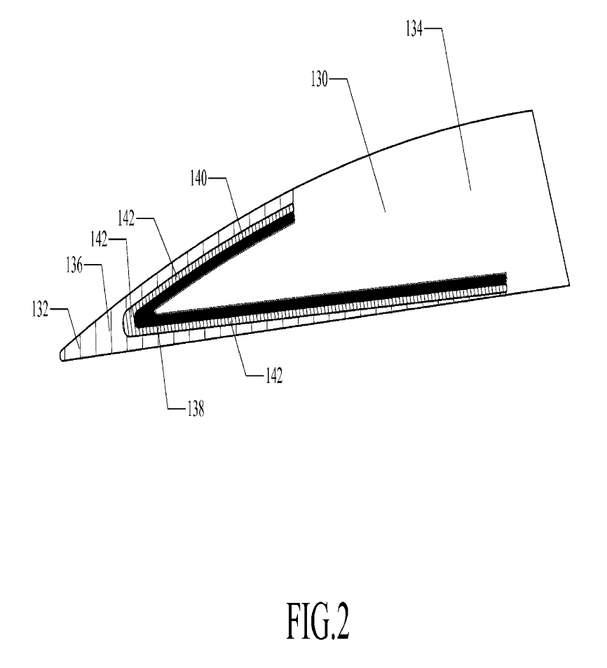

Referring now to FIGS. 1 and 2, a composite component 130 adhesively bonded to a metallic feature 132 is shown. The composite component 130 and the metallic feature 132 may be structural or operative components for use in various applications. As a non-limiting example, the composite component 130 may be an airfoil 134 of a gas turbine engine and the metallic feature 132 may be a sheath 136 configured to protect a leading edge 138 of the airfoil 134. However, those of ordinary skill in the art will understand that the composite component 130 and the metallic component 132 may exhibit various other structures and applications.

The composite component 130 may have one or more metal platings 140 deposited on one or more of its outer surfaces, as best shown in FIG. 2. In particular, the metal plating 140 may be deposited at least on portions of the outer surfaces of the composite component 130 that are bonded to the metallic feature 132. An adhesive layer 142 containing an epoxy or an adhesive may be located between the metal plating 140 and the metallic feature 132. In the exemplary arrangement illustrated in FIG. 2, the metal plating 140 may be deposited on the leading edge 138 of the airfoil 134 such that the metallic feature 132 may bond to the metal plating 140 via the adhesive layer 142, as shown. The metal plating 140 may consist of one or more platable metals such as, but not limited to nickel, cobalt, copper, iron, gold, silver, palladium, rhodium, chromium, zinc, tin, cadmium, and alloys with any of the foregoing elements comprising at least 50 wt. % of the alloy, or combinations thereof.

Importantly, the metal plating 140 may allow a metal-to-metal interface, as opposed to a metal-to-composite (or polymer) interface, to be formed between the metallic feature 132 and the composite component 130 such that the selection and optimization of suitable epoxy adhesives or other adhesives for the adhesive layer 142 may be substantially simplified. In addition, the strength of the adhesive bonding at the metal-to-metal interface may be substantially increased compared to the strength of adhesive bonding at a metal-to-composite interface. Consequently, the metal plating 140 may provide favorable reductions in cost, validation, and testing required for optimizing adhesives and adhesive bonding cycles. Even further, the interfacial shear strength between the metal plating 140 and the composite component 130 may be in the range of about two to four thousand pounds per square inch (about 140 to 280 kilograms per square centimeter) which is at least as good as, or better than, typical interfacial shear strengths between adhesives and composite materials. Various interfacial bond strength enhancement features may be applied between the metal plating 140 and the composite component 130 to further increase interfacial shear strength. The adhesive layer 142 may also advantageously serve to electrically insulate the metallic feature 132 and the metal plating 140, thereby assisting to prevent galvanic corrosion. Due to the protection against galvanic corrosion provided by the adhesive layer 142, the metallic feature 132 and the metal plating 140 may be formed from dissimilar metals.

The composite component 130 may be formed from a polymeric matrix which may optionally be reinforced with metal fiber, carbon fiber, and/or glass fiber reinforcement materials embedded in the polymer matrix. The polymer matrix may be formed from a thermoplastic material or a thermoset material. Suitable thermoplastic materials may include, but are not limited to, polyetherimide (PEI), thermoplastic polyimide, polyether ether ketone (PEEK), polyether ketone ketone (PEKK), polysulfone, polyamide, polyphenylene sulfide, polyester, polyimide, and combinations thereof. Suitable thermoset materials may include, but are not limited to, condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof. The metallic feature 132 may be formed from one or more high-strength metals including, but not limited to, titanium, nickel, or a nickel-cobalt alloy. However, the metallic feature 132 may also be formed from any metal suitable for its intended application.

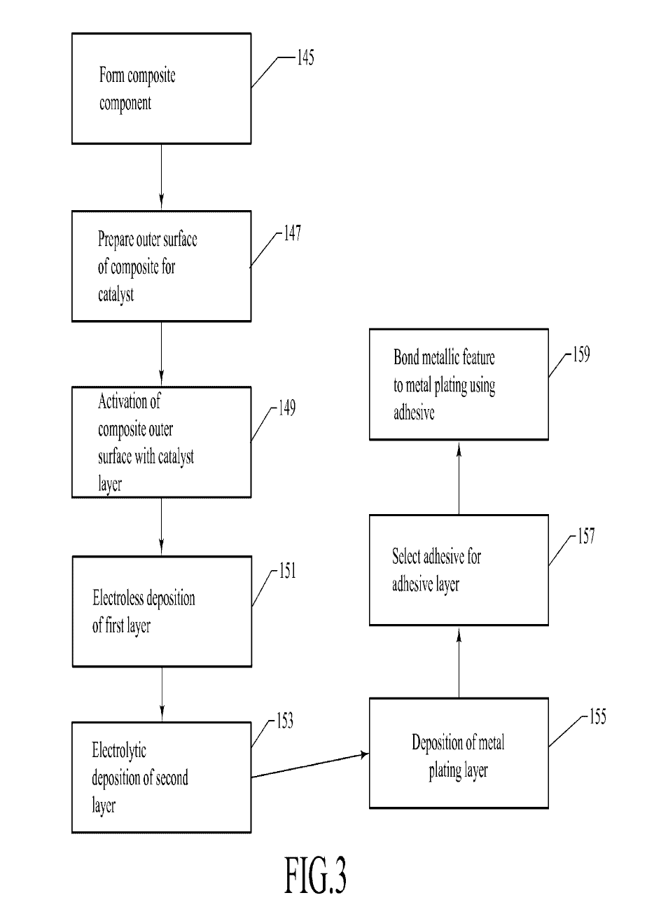

A series of steps which may be performed for the fabrication of the composite component 130 adhesively bonded to the metallic feature 132 are depicted in FIG. 3. In a first block 145, the composite component 130 having a desired shape may be formed from the thermoset or thermoplastic materials described above with optional reinforcing fibers. Forming of the composite component 130 in the desired shape may be achieved by any suitable method selected by a skilled artisan such as, but not limited to, injection molding, compression molding, blow molding, additive manufacturing (liquid bed, powder bed, deposition processes), or composite layup (autoclave, compression, or liquid molding). According to a next block 147, outer surfaces of the composite component 130 selected for plating with the metal plating 140 may be prepared for receiving a catalyst. The selected outer surfaces may be prepared in a variety of ways including, but not limited to, etching, abrasion, or reactive-ion etching.

The outer surfaces of the composite component 130 prepared by the block 147 may then be activated by depositing the catalyst layer according to the block 149, as shown. The catalyst layer may consist of palladium, but platinum and gold are other possibilities. The catalyst layer may be deposited on the prepared outer surfaces of the composite component 130 at a thickness on the atomic scale. Subsequent to the activation with the catalyst, a first layer may be applied to the activated surfaces by electroless (current-free) deposition according to the block 151. The first layer may be nickel. According to a next block 153, a second layer may be deposited on the first layer via electrolytic deposition. The second layer may be copper but other suitable conductive materials may also be used, such as silver or conductive graphite. Following the block 153, the outer surfaces of the composite component 130 having the second layer deposited thereon may exhibit conductive surface properties similar to a metal, thereby allowing deposition of the metal plating 140 on the second layer according to a block 155, as shown. At this stage, the metal plating 140 may be deposited on the second layer using a metal deposition technique apparent to those having ordinary skill in the art, including, but not limited to, electroplating, electroless plating, or electroforming. If desired, additional metal plating layers, having the same or different compositions than the first metal plating layer, may subsequently be applied on the first metal plating layer using electroplating, electroless plating, electroforming, or any other method selected by a skilled artisan. It is noted that those outer surfaces of the composite component 130 not selected for plating may be appropriately blocked during deposition of the metal plating 140 using masking techniques understood by those skilled in the art.

According to a next block 157, one or more suitable epoxy and/or adhesive compounds for forming the adhesive layer 142 may be selected. In particular, the selected epoxy and/or adhesives may be chosen for their ability to form a strong adhesive bond at a metal-to-metal interface. Subsequent to the block 157, the metallic feature 132 may be bonded to the metal plating 140 via the adhesive layer 142 (containing the selected epoxy and/or adhesive compounds) according to the block 159, as shown.

### INDUSTRIAL APPLICABILITY

From the foregoing, it can therefore be seen that the present disclosure can find industrial applicability in many situations, including, but not limited to, situations requiring the bonding of metallic features to polymer-based composite components. By plating the outer surfaces of the composite component with a metal plating layer, a metal-to-metal interface may be formed between the outer surface of the composite component and the metallic feature. Accordingly, the selection and optimization of suitable adhesives for bonding at the metal-to-metal interface, as compared with a metal-to-composite interface, may be substantially simplified. This may result in stronger bonding at the metal-to-metal interface as well as advantageous reductions in labor costs required for testing and optimization of suitable adhesives. The technology as disclosed herein may find wide industrial applicability in a wide range of areas such as, but not limited to, aerospace and transportation industries.

What is claimed is:

1. A composite component, comprising:
a metal plating deposited on a surface of the composite component;
a metallic feature adhesively bonded to the metal plating; and
an adhesive layer between the metal plating and the metallic feature.

2. The component of claim 1, wherein the metal plating provides a metal-to-metal interface between the surface of the composite component and the metallic feature.

3. The component of claim 2, wherein the composite component is formed from a polymeric matrix.

4. The component of claim 3, wherein the polymeric matrix is reinforced with fibers selected from the group consisting of metal fibers, carbon fibers, and glass fibers.

5. The component of claim 3, wherein the polymeric matrix is a thermoplastic material or a thermoset material.

6. The component of claim 5, wherein the metallic feature is formed from a metal or a metal alloy selected from the group consisting of titanium, nickel, and a nickel-cobalt alloy.

7. The component of claim 5, wherein the composite component is an airfoil of a gas turbine engine.

8. The component of claim 7, wherein the surface of the composite component is a leading edge of the airfoil, and wherein the metallic feature is a sheath configured to protect the leading edge.

9. A method for fabricating a composite component adhesively bonded to a metallic feature, comprising:
forming the composite component in a desired shape;
depositing a metal plating on a surface of the composite component;
selecting an adhesive for bonding the metallic feature to the metal plating of the composite component; and
adhesively bonding the metallic feature to the metal plating using the selected adhesive.

10. The method of claim 9, wherein selecting the adhesive for bonding the metallic feature to the metal plating comprises selecting an adhesive capable of providing a bond at a metal-to-metal interface.

11. The method of claim 10, wherein forming the composite component in a desired shape comprises forming the composite component from a thermoplastic material or a thermoset material.

12. The method of claim 10, wherein forming the composite component in a desired shape comprises forming the composite component from a thermoplastic material or a thermoset material, the thermoplastic material or the thermoset material having fibers embedded therein.

13. The method of claim 12, wherein forming the composite component in a desired shape further comprises forming the composite component by a method selected from the group consisting of injection molding, compression molding, blow molding, additive manufacturing, and composite layup.

14. The method of claim 13, wherein depositing the metal plating on the surface of the composite component comprises:
preparing the surface of the composite component to receive a catalyst by etching, abrasion, or reactive-ion etching;
depositing a catalyst layer on the surface of the composite component;
depositing a first layer on the catalyst layer by electroless deposition;
depositing a second layer on the first layer by electrolytic deposition, the second layer being conductive; and
depositing the metal plating on the second layer.

15. The method of claim 14, wherein depositing the metal plating on the second layer is performed by a method selected from the group consisting of electroplating, electroless plating, and electroforming.

16. A composite component adhesively bonded to a metallic feature, the composite component being formed by a method comprising:
forming the composite component in a desired shape;
depositing a metal plating on a surface of the composite component;
selecting an adhesive for bonding the metallic feature to the metal plating of the composite component; and
adhesively bonding the metallic feature to the metal plating using the selected adhesive.

17. The composite component of claim 16, wherein selecting the adhesive for bonding the metallic feature to the metal plating comprises selecting an adhesive capable of providing a bond at a metal-to-metal interface.

18. The composite component of claim 17, wherein forming the composite component in a desired shape comprises forming the composite component from a thermoplastic material or a thermoset material.

19. The composite component of claim 19, wherein depositing the metal plating on the surface of the composite component comprises:
preparing the surface of the composite component to receive a catalyst by etching, abrasion, or reactive-ion etching;
depositing a catalyst layer on the surface of the composite component;
depositing a first layer on the catalyst layer by electroless deposition;
depositing a second layer on the first layer by electrolytic deposition, the second layer being conductive; and
depositing the metal plating on the second layer.

20. The composite component of claim 19, wherein the composite component is an airfoil of a gas turbine engine, and wherein the metallic feature is a sheath configured to protect a leading edge of the airfoil.
